(19) United States
(12) Patent Application Publication
(10) Pub. No.: US 2007/0259065 A1
(43) Pub. Date: Nov. 8, 2007

(54) Apparatus to Shape the Interior Surface of a Pipe made of Thermoplastic Material

(75) Inventors: Adalbert Haberle, Rain am Lech/Etting (DE); Michael Kellner, Rain (DE); Claus Hetzner, Zirndorf (DE)

Correspondence Address: FISH & RICHARDSON PC, P.O. BOX 1022, MINNEAPOLIS, MN, 55440-1022, US

(73) Assignee: DROSSBACH GMBH & CO. KG

(21) Appl. No.: 11/736,103

(22) Filed: Apr. 17, 2007

(30) Foreign Application Priority Data
Apr. 20, 2006 (DE) 10 2006 018 373.8

(51) Int. Cl. A21C 3/00

(52) U.S. Cl. 425/130; 425/405.1

(57) ABSTRACT

The disclosure pertains to an apparatus to shape the interior surface of a pipe made of thermoplastic material, where the apparatus includes a shaping component. the surface of this shaping component can have at least one notch and at least one smooth continuous surface area. The shaping component can have at least partially a cylindrical shape and/or at least partially a conical shape. The notch or notches can run spirally or closed and can either extend over the entire length of the shaping component or can only be located along a specific length of the shaping component. The notch or notches can be connected to a pressure system to produce vacuum and/or positive pressure in the notch. This can facilitate enhanced feeding and gliding of the interior surface of the pipe at the shaping component. The disclosure also pertains to a system to manufacture pipes made of thermoplastic material, where the system includes an above apparatus to shape the interior surface of a pipe made of thermoplastic material.

### CROSS-REFERENCE TO RELATED APPLICATION

This application claims priority under 35 U.S.C. §119 to DE 10 2006 018 373.8, filed Apr. 20, 2006, the contents of which are hereby incorporated by reference.

### FIELD

The disclosure pertains to an apparatus to shape the interior surface of a pipe made of thermoplastic material, where the apparatus includes a shaping component. The disclosure also pertains to a system to manufacture pipes made of thermoplastic material, where the system includes the above apparatus to shape the internal surface of a pipe made of thermoplastic material.

### BACKGROUND

Pipes made of thermoplastic materials, having an internal and an external surface, and usually with a circular cross section, can be manufactured using so-called corrugators. These thermoplastic pipes can have a wide variety of diameters, for example a relatively large diameter in a range of one to two meters as is the case in the manufacture of wastewater pipes.

Systems to manufacture pipes made of thermoplastic material are known which, in addition to an apparatus to shape the internal surface of a pipe made of thermoplastic material using a shaping component (also called “calibration”), can include a nozzle component to feed or extrude at least one thermoplastic flow stream, as well as shaping dies to shape the exterior surface.

### SUMMARY

The disclosure provides an apparatus to shape the internal surface of a pipe made of thermoplastic material such that an improved feeding and sliding of the internal surface of the pipe on the shaping component is achieved.

In one aspect, the disclosure provides an apparatus to shape the interior surface of a pipe made of thermoplastic material. The apparatus includes a shaping component with a longitudinal axis, and the surface of the shaping component contains at least one notch and at least one smooth continuous surface area.

In another aspect, the disclosure provides a system configured to produce pipes made of thermoplastic material, where the pipes each including an inside surface and an outside surface. The system includes a nozzle component to feed or extrude at least one thermoplastic material flow stream, and dies configured to shape the outside surface of the pipes. The system also includes an apparatus configured to shape the inside surface of the pipes. The apparatus includes a shaping component with a longitudinal axis, and the surface of the shaping component contains at least one notch and at least one smooth continuous surface area.

According to the disclosure, the apparatus to shape the internal surface of a pipe made of thermoplastic material includes a shaping component having a longitudinal axis. According to the disclosure, the surface of this shaping component has at least one notch and at least one smooth continuous surface area. In particular, the shaping component has an at least partially cylindrical and/or at least partially conical shape.

Expressed reference is made to the fact that the shaping component can of course have as many notches as desired. For purposes of simplification, however, only one notch is described below, or a first and a second notch. However, corresponding embodiments can of course apply for one or more other notches on the surface of the shaping component as well.

The notch can be connected to a pressure system to produce a vacuum and/or positive pressure in the notch in order to control and if necessary modify the precise shape of the internal surface of the pipe made of thermoplastic material or the friction of the internal surface of the pipe against the shaping component. To do this it is not necessary to break the continuity of the shaping component, i.e. to change the geometry of the shaping component.

The notch can run along the perimeter closed or spirally and can either extend over the entire length of the shaping component or can be restricted to a specific length of the shaping component only. “Closed along the perimeter” is understood to mean that the notch runs closed around the mostly cylindrical shaping component and thus depicts a circle in a cross section of the shaping component. “Spirally” is understood to mean that the notch runs spirally around the mostly cylindrical shaping component and thus has two ends that are not connected.

The surface of the shaping component can have a second notch which can likewise run along the perimeter closed or spirally and can extend either over the entire length of the shaping component or can be restricted to a specific length of the shaping component only.

In some embodiments, the first notch and the second notch can both run spirally. The two notches can be wound inside of one another, i.e. they can run along the perimeter without crossing one another, wherein in particular the notches run parallel along the perimeter. In particular, the surface can contain precisely four spiral notches so wound inside of one another.

In certain embodiments, the first and the second notch can be arranged one after the other or next to one another relative to the longitudinal axis of the shaping component. In particular, the first notch can run closed along the perimeter. Of course, more than one such notch can be arranged one after the other closed along the perimeter. The second notch can run spirally and be located behind the first notch relative to the longitudinal axis of the shaping component, in other words farther away from the nozzle component than the first notch. Alternatively, the arrangement of the two notches relative to the longitudinal axis of the shaping component can also be interchanged so that the second spiral notch is located closer to the nozzle component than the first notch that runs along the perimeter.

In some embodiments, the first and second notch can both run spirally and be located one after the other or next to one another relative to the longitudinal direction of the shaping component. The width of the smooth continuous surface areas of the two notches can be different, in other words the spiral notches can run at a different “tightness” around the shaping component.

The apparatus includes at least one connection mechanism to connect to a pressure system, where the connection mechanism is connected to at least one notch of the shaping component. In particular, holes can be made in the at least one notch of the shaping component at an angle to connect to the pressure system.

The pressure system can include a system to produce a positive pressure. This pressure system can be connected to at least one of the connection mechanism so as to produce a positive pressure in at least one notch, wherein the positive pressure can be used in particular to force the thermoplastic material away from the surface of the shaping component. The interior surface of the pipe can thus glide on an “air cushion” that forms between the surface of the shaping component and the thermoplastic material. This lowers or eliminates the normal force of the thermoplastic material against the shaping component and reduces the frictional forces between the interior surface of the pipe and the shaping component. Also, the thermoplastic material can be cooled this way. In some embodiments, the pressure system can produce only a slight positive pressure; in particular the positive pressure is less than 0.5 bar, in particular about 0.1 bar.

Alternatively, or cumulatively, the pressure system can include a system to produce a vacuum. This pressure system can be connected to at least one of the connection mechanism in order to produce a vacuum in at least one notch, wherein the vacuum can be used in particular to draw in the thermoplastic material against the surface of the shaping component. This can improve the precise shape of the interior surface of the pipe made of thermoplastic material at the shaping component.

In another alternative, the notches can also be provided with periodically alternating vacuum and positive pressure.

In certain embodiments, a notch located closer to the nozzle component is provided with vacuum in order to draw in the material and feed it tightly against the shaping component. Another notch farther away can be provided with positive pressure in order to prevent the cooling, but still soft material from depositing in the notch, thus resulting in displacement of the interior surface of the pipe.

In order to connect the pressure system to the notches, the nozzle component can include at least one feed channel, in particular two feed channels, through which vacuum or positive pressure can be fed to the at least one connection mechanism.

Such an apparatus according to the disclosure to shape the interior surface of a pipe made of thermoplastic material can be used in a system to manufacture pipes made of thermoplastic material according to one of the embodiments described above. The system further includes a nozzle component to feed or extrude at least one thermoplastic material flow stream and dies to shape the exterior surface.

The nozzle component can include an outer nozzle and an inner nozzle with at least one nozzle channel in between them that ends at a nozzle opening. Each nozzle channel can feed a thermoplastic material flow stream.

The system can be designed to manufacture double-walled pipes made of a thermoplastic material, the pipes include an inner pipe and an outer pipe. Here, the nozzle component includes [an outer nozzle and an inner nozzle] with two separate and distinct nozzle channels located in between them. A first nozzle channel can feed a first material stream and a second nozzle channel can feed a second material stream, wherein the first nozzle channel ends at a first nozzle opening and the second nozzle channel ends at a second nozzle opening. The inner pipe is formed from the first material stream that flows through the first nozzle channel and exits from the first nozzle opening. The outer pipe is formed from the second material stream that flows through the second nozzle channel and exits from the second nozzle opening. Here, the first nozzle opening is located behind the second nozzle opening along the longitudinal axis in the direction of flow of the material, i.e. it is farther away from the nozzle component than the second nozzle opening. This ensures that the second material flow stream that forms the outer pipe exits before the first material flow stream that forms the inner pipe in the direction of flow of the material.

In particular, the system can be designed to manufacture a double-walled corrugated pipe that has a smooth inner pipe and a corrugated outer pipe. The smooth inner pipe can be formed by a material stream that exits at a first nozzle opening. The dies can exhibit a corrugated inside which shapes the outer pipe. The inner folds of the outer pipe so produced can be connected to the smooth inner pipe so that cavities form between the outer and the inner pipe.

The system can furthermore include a distributor component located along the longitudinal axis in the direction of material flow prior to the nozzle component. This distributor component feeds the at least one thermoplastic material flow stream to the nozzle component.

### BRIEF DESCRIPTION OF THE DRAWINGS

The disclosure is explained below with the aid of embodiments, with reference to the attached drawings.

FIG. 1 shows an apparatus to shape the inner surface of a pipe made of thermoplastic material, as well as a part of a system to manufacture pipes made of thermoplastic material;

FIG. 2 shows an apparatus to shape the inner surface of a pipe made of thermoplastic material, as well as a part of a system to manufacture pipes made of thermoplastic material;

FIG. 3 shows an apparatus to shape the inner surface of a pipe made of thermoplastic material, as well as a part of a system to manufacture pipes made of thermoplastic material;

FIG. 4 shows an apparatus to shape the inner surface of a pipe made of thermoplastic material, as well as a part of a system to manufacture pipes made of thermoplastic material; and

FIG. 5 shows an apparatus to shape the inner surface of a pipe made of thermoplastic material, as well as a part of a system to manufacture pipes made of thermoplastic material.

### DETAILED DESCRIPTION

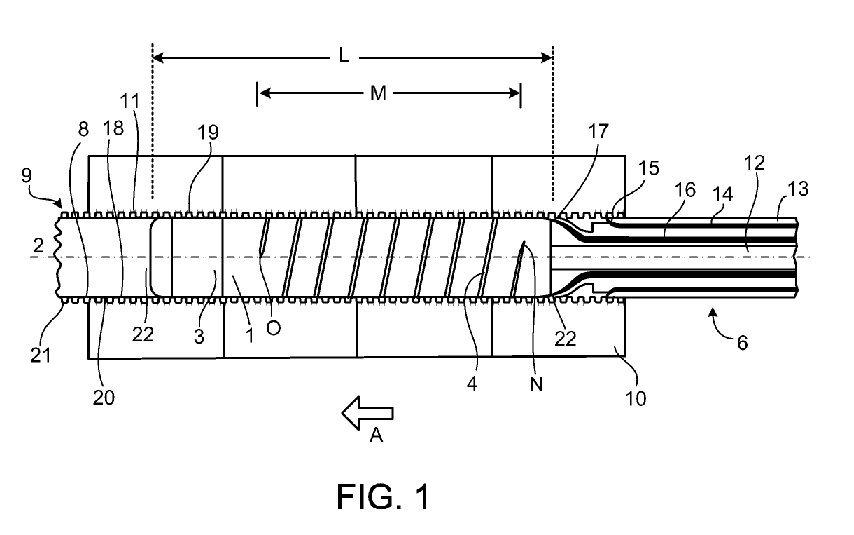

According to the disclosure, the apparatus shown in FIG. 1 to shape the inner surface of a pipe made of thermoplastic material includes a shaping component 1 with a longitudinal axis 2. According to the disclosure, the surface 3 of this shaping component contains at least one notch 4 and at least one smooth continuous surface area. The central portion of the shaping component 1 has a cylindrical shape and is conical at its transverse sides 22.

In the first embodiment shown in FIG. 1, the notch 4 runs spirally along the perimeter and does not extend over the entire length L of the shaping component 1, but is restricted to a specific length M of the shaping component 1 only. “Spiral” is understood to mean that the notch 4 runs spirally around the cylindrically shaped shaping component 1, and thus has two ends which do not connect with one another, a starting point N and an end point O.

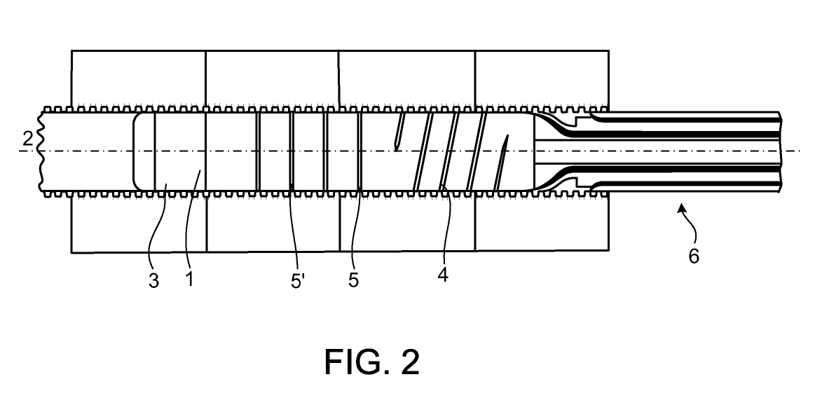

In FIG. 2, the surface 3 of the shaping component 1 has a first notch 4 and a second notch 5, wherein notch 5 runs closed along the perimeter. “Closed along the perimeter” is understood to mean that the notch 5 runs closed around the cylindrical shaping component 1 and thus depicts a circle in a cross section of the shaping component 1. In the second embodiment of the disclosure shown in FIG. 2, the first notch 4 and the second notch 5 are arranged one after the other or next to one another relative to the longitudinal axis 2 of the shaping component 1. The second notch 5 is located behind the first notch 4 relative to the longitudinal axis 2 of the shaping component 1, i.e. farther away from a nozzle component 6 than the first notch 4. There are three notches 5′, which are likewise closed along the perimeter, behind the second notch 5 relative to the longitudinal axis 2 of the shaping component 1.

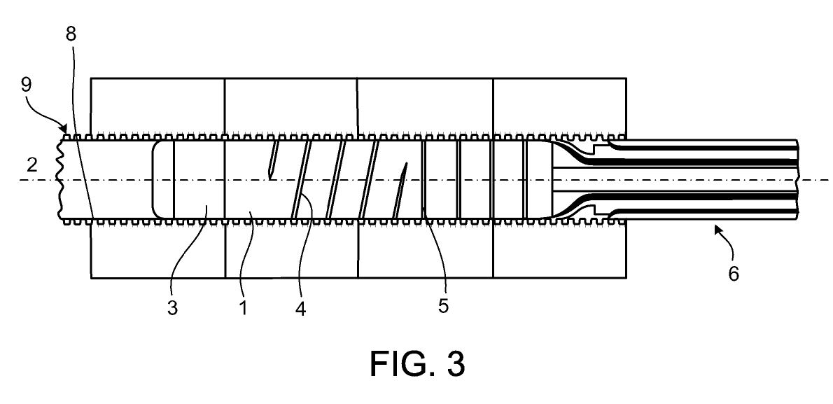

Alternatively, the arrangement of the two notches 4 and 5 relative to the longitudinal axis 2 of the shaping component 1 can also be interchanged so that the second notch 5 running along the perimeter is located closer to the nozzle component 6 than the first spiral notch 4 (see FIG. 3).

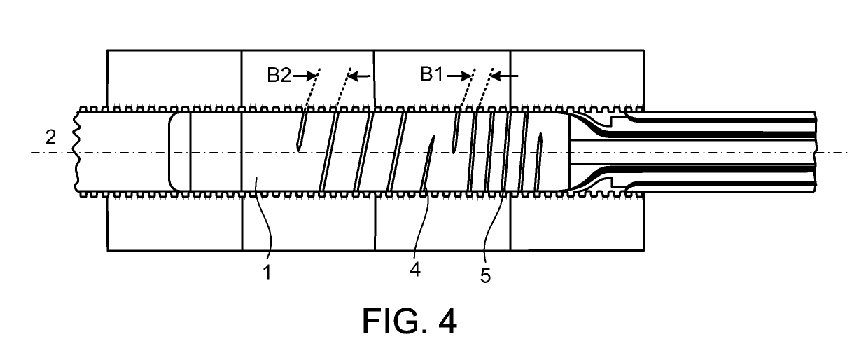

In a fourth embodiment shown in FIG. 4, the first notch 4 and the second notch 5 both run spirally and are one after the other or next to one another relative to the longitudinal axis 2 of the shaping component 1. The width (B1, B2) of the smooth continuous surface areas of the two notches (4, 5) is different for each notch, in other words the spiral notches (4, 5) run around the shaping component 1 with different degrees of “tightness”.

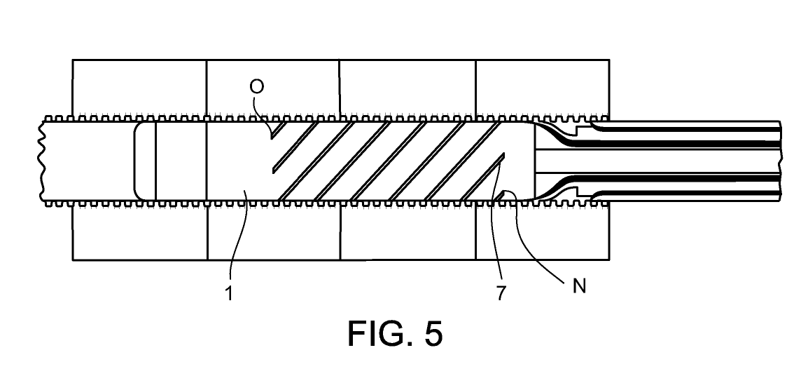

In the fifth embodiment of the disclosure shown in FIG. 5, the surface of the shaping component has six notches, all of which run spirally. These notches are wound inside of one another, i.e. the run along the perimeter without crossing one another, the notches running parallel along the perimeter. Here, the starting points N of only three of the six notches are shown on the longitudinal side of the shaping component 1 facing the observer. The starting points of the other three notches are located on the opposite longitudinal side of the shaping component 1.

The apparatus contains at least one connection mechanism to connect to a pressure system, the connection mechanism being connected to at least one notch of the shaping component 1. To this end, holes 7 can be made in the at least one notch of shaping component 1 as shown in FIG. 5, to connect to the pressure system.

Each of the notches shown in FIG. 1 through FIG. 5 can be connected to a pressure system to produce vacuum and/or positive pressure in the respective notch. It is not necessary to break the continuity of the shaping component, i.e. to change its geometry.

The pressure system can include a system to produce a positive pressure that connects to a connection mechanism, thereby producing a positive pressure in notch 4, wherein the positive pressure can be used in particular to force the thermoplastic material away from the surface 3 of shaping component 1 (see FIG. 1). In this way, the inner surface 8 of the pipe 9 can glide along an “air cushion” that is formed between the surface 3 of the shaping component 1 and the thermoplastic material. This lowers or eliminates the normal force of the thermoplastic material against the shaping component 1 and reduces the frictional forces between the interior surface 8 of the pipe 9 and the shaping component 1. Also, the thermoplastic material can be cooled this way. In some embodiments, the pressure system produces only a slight positive pressure; in particular the positive pressure is less than 0.5 bar, in particular about 0.1 bar.

Alternatively, or cumulatively, the pressure system can include a system to produce a vacuum. This pressure system is connected to a connection mechanism in order to produce a vacuum in notch 4, wherein the vacuum can be used in particular to draw in the thermoplastic material against the surface 3 of the shaping component 1. This can improve the precise shape of the interior surface 8 of the pipe 9 made of thermoplastic material at the shaping component 1.

In another alternative, notch 4 can also be provided with periodically alternating vacuum and positive pressure.

In the embodiment shown in FIG. 3, the second notch 5 located closer to the nozzle component 6 is provided with vacuum in order to draw in the material and bring it tight against the shaping component 1. The first notch 4 that is farther away can be provided with positive pressure in order to prevent the cooling, but still soft material from depositing in notch 4, thus preventing displacement of the interior surface 8 of the pipe 9 from occurring.

Such an apparatus according to the disclosure to shape the interior surface 8 of a pipe 9 made of thermoplastic material can be used in a system to manufacture pipes made of thermoplastic material according to some embodiments of the disclosure. The system further includes a nozzle component 6 to feed or extrude at least one thermoplastic material flow stream and dies 10 to shape the exterior surface 11.

The system can be designed to manufacture double-walled pipes made of a thermoplastic material, the double-walled pipes including an inner pipe 18 and an outer pipe 19 (see FIG. 1). Here, the nozzle component 6 includes an outer nozzle 12 and an inner nozzle 13 with two separately distinct nozzle channels (14, 16) located between them. A first nozzle channel 14 can feed a first material stream and a second nozzle channel 16 can feed a second material stream, wherein the first nozzle channel 14 ends at a first nozzle opening 15 and the second nozzle channel 16 ends at a second nozzle opening 17. The inner pipe 18 is formed from the first material stream that flows through the first nozzle channel 14 and exits from the first nozzle opening 15. The outer pipe 19 is formed from the second material stream that flows through the second nozzle channel 16 and exits from the second nozzle opening 17. Here, the first nozzle opening 15 is located behind the second nozzle opening 17 along the longitudinal axis 2 in the direction of flow A of the material, i.e. it is farther away from the nozzle component 6 than the second nozzle opening 17. This ensures that the second material flow stream that forms the outer pipe 19 exits before the first material flow stream that forms the inner pipe 18 in the direction of flow A of the material.

In particular, the system can be designed to manufacture a double-walled corrugated pipe that has a smooth inner pipe 18 and a corrugated outer pipe 19, as shown in FIG. 1. The smooth inner pipe 18 is formed by the material stream that exits at the first nozzle opening 15. The dies 10 have a corrugated inside which shape the outer pipe 19. The inner folds 20 of the outer pipe thus produced can be connected to the smooth inner pipe 18 so that cavities 21 form between the outer pipe 19 and the inner pipe 18.

The system can furthermore include a distributor component (not shown) located along the longitudinal axis 2 in the direction A of material flow prior to the nozzle component 6. This distributor component feeds the at least one thermoplastic material flow stream to the nozzle component 6.

In order to connect the pressure system to the notches, the nozzle component 6 can include at least one feed channel (not shown), in particular two feed channels, through which vacuum or positive pressure can be fed to the at least one connection mechanism.

1. An apparatus, comprising:
a shaping component with a longitudinal axis, a surface of the shaping component having at least one notch and at least one smooth continuous surface area,
wherein the apparatus is configured to shape an interior surface of a pipe made of thermoplastic material.

2. An apparatus according to claim 1, wherein the shaping component has at least partially a cylindrical shape and/or at least partially a conical shape.

3. An apparatus according to claim 1, wherein a first notch runs closed or spirally along the perimeter.

4. An apparatus according to claim 3, wherein at least a second notch runs closed or spirally along the perimeter.

5. An apparatus according to claim 4, wherein the first and the at least second notch are arranged one after the other or next to one another relative to the longitudinal axis of the shaping component.

6. An apparatus according to claim 3, wherein the first notch and the at least second notch run spirally such that both are wound inside of one another.

7. An apparatus according to claim 1, further comprising at least one connection mechanism configured to connect the apparatus to a pressure system.

8. An apparatus according to claim 7, wherein the at least one connection mechanism is connected to at least one notch of the shaping component.

9. An apparatus according to claim 8, wherein the pressure system comprises a system to produce a positive pressure, the system is connected to a first connection mechanism in order to produce a positive pressure in the first notch, and the positive pressure can be used to force the thermoplastic material away from the surface of the shaping component.

10. An apparatus according to claim 8, wherein the pressure system comprises a system to produce a vacuum, the system is connected to at least a second connection mechanism in order to produce a vacuum in the at least second notch, and the vacuum can be used to draw in the thermoplastic material against the surface of the shaping component.

11. A system configured to produce pipes made of thermoplastic material, the pipes each including an inside surface and an outside surface, the system comprising:
a nozzle component to feed or extrude at least one thermoplastic material flow stream;
dies configured to shape the outside surface of the pipes; and
the apparatus of claim 1 configured to shape the inside surface of the pipes.

12. A system according to claim 11, wherein the nozzle component includes an outer nozzle and an inner nozzle with at least one nozzle channel in between them that ends at a nozzle opening to feed the at least one thermoplastic material flow stream.

13. A system according to claim 11, wherein the nozzle component has an outer nozzle and an inner nozzle with two nozzle channels in between them separate from one another, namely a first nozzle channel to feed a first material flow stream and a second nozzle channel to feed a second material flow stream, wherein the first nozzle channel ends at a first nozzle opening and the second nozzle channel ends at a second nozzle opening.

14. A system according to claim 13, wherein the system is designed to manufacture double-walled pipes made of thermoplastic material, the pipes comprising an inner pipe and an outer pipe, respectively.

15. A system according to claim 14, wherein the inner pipe is formed from the first material stream that flows through the first nozzle channel and exits from the first nozzle opening, and the outer pipe is formed from the second material stream that flows through the second nozzle channel and exits from the second nozzle opening.

16. A system according to claim 15, wherein the first nozzle opening is located behind the second nozzle opening along the longitudinal axis in the direction of flow of the material.

17. A system according to claim 14, wherein the system is designed to manufacture a double-walled corrugated pipe that comprises a smooth inner pipe and a corrugated outer pipe, which can be shaped using dies with a corrugated inside, wherein the inner folds of the outer pipe can be connected to the smooth inner pipe so that cavities can form between the outer and the inner pipe.

18. A system according to claim 14, wherein the nozzle component comprises at least one feed channel, in particular two feed channels, by which vacuum or positive pressure can be fed to at least one of the connection mechanism.

19. A system according to claim 14, wherein the system further comprises a distributor component located in front of the nozzle component along the longitudinal axis in the direction of flow of the material, the distributor component used to feed the at least one thermoplastic material stream to the nozzle component.
